(19) United States
(12) Patent Application Publication
(10) Pub. No.: US 2021/0207417 A1
(43) Pub. Date: Jul. 8, 2021

(54) DOOR CLOSER

(71) Applicant: SCWINNERS CO., LTD., Siheung-si, Gyeonggi-do (KR)

(72) Inventors: Hong Doo KOO, Uiwang-si, Gyeonggi-do (KR); Chung Hyun RYU, Suwon-si, Gyeonggi-do (KR)

(73) Assignee: SCWINNERS CO., LTD., Siheung-si, Gyeonggi-do (KR)

(21) Appl. No.: 16/069,174

(22) PCT Filed: Nov. 29, 2017
(86) PCT No.: PCT/KR2017/013752

§ 371 Date: Jul. 11, 2018

(30) Foreign Application Priority Data
Feb. 3, 2017 (KR) 10-2017-0015355
Nov. 23, 2017 (KR) 10-2017-0157431

(51) Int. Cl. E05F 3/20; E05F 1/10

(52) U.S. Cl. CPC E05F 3/20; E05F 3/14; E05F 1/10

(57) ABSTRACT

The invention relates to a door closer having high usability and capable of saving installation cost. The door closer according to an example embodiment of the inventive concept includes a first closer part combined with a doorframe and a door to provide a rotational force in a direction in which the door is closed, and a second closer part to reduce a rotational speed of the door by a damping force of a viscous fluid contained thereinside when the door is closed by the first closer part.

### TECHNICAL FIELD

The invention relates to a door closer. More specifically, the invention relates to a door closer having high usability and capable of saving installation cost.

### BACKGROUND ART

Generally, a door closer is used to prevent a door from being suddenly closed or to automatically close the door by controlling a rotational force when the door is opened and closed.

Korean Patent No. 1563936 discloses an auto/manual door opening and closing method using an auto/manual door opening and closing system. In the door opening and closing system of the prior art mentioned above, since most of configurations for opening and closing and configurations for releasing hydraulic pressure are provided inside the door, there is a problem that the door itself needs to be replaced to apply such door opening and closing system to a door already installed. In addition, this may cause a problem of increasing installation cost.

Korean Utility Model No. 0431191 discloses an automatic closing device for a door. In the automatic closing device of the prior art mentioned above, since a hydraulic door checker, a hydraulic cylinder, a first operating rod, a second operating rod, and the like are provided so as to be exposed to outside of the door and a wall, there is a risk of damage due to external impact. In addition, there is a problem that the above configurations are difficult to apply in the case when the door and the wall already installed do not secure a space for providing the above-mentioned configuration.

Accordingly, a door closer which have a high usability due to low constraint by installation type of already installed door, and may save installation cost is required.

### DISCLOSURE OF THE INVENTION

### Problem to be Solved

To solve the above problems, the present invention provides a door closer having high usability and capable of saving installation cost.

### Technical Solution

To solve these problems, a door closer according to an example embodiment of the inventive concept includes a first closer part combined with a doorframe and a door to provide a rotational force in a direction in which the door is closed, and a second closer part to reduce a rotational speed of the door by a damping force of a viscous fluid contained thereinside when the door is closed by the first closer part.

In an example embodiment, first closer part may include a first fixing part including a first receiving portion, a second fixing part including a second receiving portion and a third receiving portion which are disposed at both ends of the first receiving portion to hinge-rotate with the first fixing part, a first housing part disposed inside of the first receiving portion, the second receiving portion and the third receiving portion to combine the first fixing part with the second first fixing part, and having a cylindrical shape, a first ratchet part fixed inside of the second receiving portion, and a rotational force providing part disposed inside of the first housing part. One end of the rotational force providing part may be combined with the first housing part, and another end of the rotational force providing part may be ratchet-combined with the first ratchet part and provide a rotational force by a torsional elastic force to the second fixing part.

In an example embodiment, the first receiving portion may have a first fixing protrusion protruding inward, and a first combining slit is formed along a length direction of the first housing part at the first housing part to receive the first fixing protrusion when the first housing part is inserted into the first receiving portion in a first direction.

In an example embodiment, the rotational force providing part may include a guide shaft provided in a longitudinal direction of the first housing part in the first housing part, and having a combining protrusion at an end thereof and a first combining hole in an axial direction at the other end thereof, a torsion spring provided in a length direction of the guide shaft to surround the guide shaft, a tension fixing portion which includes a fixing body combined with an end of the first housing part, a fixing groove being formed thereof to be combined with an end of the torsion spring, a first extending protrusion protruded from a surface of the fixing body and inserted into the torsion spring, and a first insert hole formed through the fixing body and the first extending protrusion along a central axis direction, an end of the guide shaft being inserted into the first insert hole so that the guide shaft reciprocate in a axial direction of the first housing part, a second ratchet part combined with the other end of the guide shaft, combined with the other end of the torsion spring, and combined with the first ratchet part in a ratchet manner.

In an example embodiment, the first ratchet part may include a first ratchet body, a second combining slit formed on an outer circumferential surface of the first ratchet body so that a second fixing protrusion which protrudes inside of the second receiving portion is inserted thereinto, a first ratchet formed along a circumferential direction on one surface of the first ratchet body to face the first housing part, and a guiding hole formed through first ratchet body in a central axis direction. The second ratchet part may include a second ratchet body on which a second fixing groove is formed to be combined with the other end of the torsion spring, a second ratchet formed on one surface of the second ratchet body to face the first ratchet to be combined with the first ratchet in a ratchet manner, a second extending portion formed on the other surface of the second ratchet body through which a second insert hole is formed, and a second guide hole formed at a center of the one surface of the second ratchet body and connected to the first guiding hole. In a state where the first ratchet part and the second ratchet part are engaged with each other, rotation of the second ratchet part may be restricted by the first ratchet part so that the torsion spring is not rotated in an opposite direction of the winding direction, and the second ratchet part may rotate only in a direction in which the torsion spring is wound.

In an example embodiment, the rotational force providing part may include a first cap combined with the third receiving portion and having a third insert hole in a central axis direction to be connected to the first insert hole, an adjustment bolt inserted through the third insert hole, combined with the first combining hole by a screw connection, and being for selectively ratchet-combining the second ratchet part and the first ratchet by reciprocating the guide shaft in the longitudinal direction of the first housing part while rotating, a second cap combined with inside of the second receiving portion, and having a third guide hole formed in the central axis direction to be connected with the first guide hole.

In an example embodiment, the second closer part may include a second hinge part including a third fixing part including a fourth receiving portion, and a fourth fixing part including a fifth receiving portion and a sixth receiving portion disposed at both ends of the fourth receiving portion to rotate with the third fixing part in a hinge manner, a second housing part disposed inside of the fourth receiving portion, the fifth receiving portion and the sixth receiving portion, and having a first guide part formed in a longitudinal direction on an inner circumferential surface of the second housing part; and a speed control part provide inside of the second housing part, wherein a portion of speed control part is combined with the second housing part, the other portion of speed control part is combined with the fifth housing part, and the speed control part reduce a rotational speed of the fourth fixing part by a damping force of a viscous fluid contained thereinside.

In an example embodiment, a third fixing protrusion may be protruded inside of the fourth receiving portion. A third combining slit may be formed on an outer circumferential surface of the second housing part in the longitudinal direction of the second housing part to receive the third fixing protrusion when the second housing part is inserted into the fourth receiving portion.

In an example embodiment, the speed control part may include a slider having a second guide part combined with the first guide part formed on an outer circumferential surface thereof so as to move in a longitudinal direction inside the second housing part, having a third guide portion formed on an inner circumferential surface thereof, and having a first flow hole being formed therethrough, an adjustment part combined with one end of the slider, formed in a longitudinal direction, and having a second flow hole which has a compressed tube portion and expanded tube portion and is formed in the axial direction of the slider, wherein a check ball is provided inside of the second flow hole, a first capping part combined with inside of one end of the second housing part to seal the one end of the second housing part so as to prevent leakage of the viscous fluid;

a control bar provided at the first capping part and inserted into a third flow hole which is formed through the adjusting part along the axial direction, and provided to be spaced apart from an inner peripheral surface of the third flow hole, an adjustment part provided at the first capping part so as to reciprocate in a longitudinal direction of the first capping part, and combined with the control bar to adjust protruded length of the control bar, a rotating shaft part having a fourth guide portion formed on an outer circumferential surface of one end thereof, a fifth guide portion formed on the outer circumferential surface of the other end thereof, and providing rotational force to move the slider linearly by rotating integrally with the fourth fixing part, a second capping part having a first through hole with which the rotating shaft part is combined, and combined to the rotating shaft part to prevent leakage of the viscous fluid, and an shaft fixing part having a sixth guide portion formed on an inner circumferential surface thereof, wherein an outer circumferential surface of the shaft fixing part is combined with the fifth receiving portion so as to transmit the rotational force to the rotating shaft part.

In an example embodiment, a fourth fixing protrusion may be protruded inward from the fifth receiving portion. A fourth combining slit may be formed on the outer circumferential surface of the shaft fixing part in a longitudinal direction of the shaft fixing part so that the fourth fixing protrusion is inserted and combined when the shaft fixing part is inserted into the fifth receiving portion.

In an example embodiment, a cover ring may be provided at the adjusting part and cover at least a portion of the expanded tube portion of the second flow hole to prevent the check ball from being discharged to the expanded tube portion of the second flow hole.

In an example embodiment, the first closer part may include a first hinge part including a first fixing part having a first receiving portion and a second fixing part having a second receiving portion and a third receiving portion which are disposed at both ends of the first receiving portion to hinge-rotate with the first fixing part, a first housing part including a core portion which is disposed inside of the first receiving portion, the second receiving portion and the third receiving portion to combine the first fixing part with the second first fixing part and has a cylindrical shape, and a head portion which is formed at one end of the core portion, extends outwardly of the second receiving portion and is provided with an adjusting slit in a circumferential direction, a rotational force providing part disposed inside of the first housing part, wherein one end of the rotational force providing part is combined with the third receiving portion, the other end of the rotational force providing part is combined with the head portion by an adjustment pin, and the and rotational force providing part provides a rotational force by a torsional elastic force to the second fixing part.

In an example embodiment, the first receiving portion may include a first fixing protrusion protruding inward, and a first combining slit is formed in a longitudinal direction of the core part at the other end of the core part so that the first fixing protrusion is inserted and fixed when the core part is inserted into the first receiving portion.

In an example embodiment, the rotational force providing part may include a guide shaft provided inside of the core portion in a longitudinal direction of the core portion, a torsion spring provided in the longitudinal direction of the guide shaft while surrounding the guide shaft, a tension fixing part provided at one end of the guide shaft, having a first fixing groove which is combined with one end of the torsion spring, and combined with the third receiving portion, a tension adjusting part provided at the other end of the guide shaft, having a second fixing groove which is combined with the other end of the torsion spring, received in the head portion, and having an adjusting groove which is formed on an outer circumferential surface of the tension adjusting part and is exposed the adjustment slit.

In an example embodiment, a second fixing protrusion may be protruded inward from the third receiving portion. A second combining slit may be formed on the outer circumferential surface of the tension adjusting part in a longitudinal direction of the tension adjusting part so that a second fixing protrusion is inserted thereinto when the tension adjusting part is inserted into the third receiving portion in a second direction.

### Effect of the Invention

According to an example embodiment of the present invention, since the first closer part and the second closer part are formed in a form of hinge, the present invention can be applied to a door that has already been installed, so that usability is high and construction cost can be saved.

In addition, according to an example embodiment of the present invention, with a first ratchet part and a second ratchet part being ratchet-engaged, the second ratchet part can be rotated only in a winding direction of a torsion spring. Thus, when the door rotates in an opening direction, the torsion spring is expanded in an opposite direction of the winding direction and becomes larger in a radial direction, and expanded in longitudinal direction at the same time, so that the second ratchet part is elastically supported by the first ratchet part. Accordingly, the second ratchet part can be continuously and reliably combined with the first ratchet part in the ratchet manner.

In addition, according to the example embodiments of the invention, the second ratchet part can be rotated by fastening a fastening tool such as a hexagonal wrench to the second guide hole from the outside, so that the degree of winding of the torsion spring can be adjusted. At this time, when the second ratchet part is rotated, a clicking sound is generated between the second ratchet and the first ratchet, so that the user can recognize the amount of rotation of the second ratchet part. The user can adjust the amount of the elastic restoring force generated by the torsion spring by adjusting the amount of rotation of the second ratchet part. Accordingly, the speed at which the door rotates in the closing direction can be adjusted.

In addition, according to the example embodiments of the invention, it is possible to adjust whether or not the second ratchet part and the first ratchet part are ratchet-combined by adjusting the adjustment bolt to move the guide shaft. Thus, the rotation restoring force by the torsion spring can be applied to the door or not applied to the door.

In addition, according to the example embodiments of the invention, the third fixing protrusion may be inserted into the third combining slit when the second housing part is inserted into the fourth housing portion. Accordingly, the second housing part can be easily rotated integrally with the third fixing part. In addition, a fourth fixing protrusion may protrude inward from the fifth receiving portion, and the fourth combing slit may be formed on the outer peripheral surface of the shaft fixing part. The fourth combining slit may be formed in the longitudinal direction of the shaft fixing part so that the fourth fixing protrusion is inserted and combined when the shaft fixing part is inserted into the fifth receiving portion. Accordingly, when the fourth fixing part rotates, the shaft fixing part also rotates in conjunction with the rotation of the fourth fixing part, so that the rotational force can be easily transmitted to the rotating shaft part, and as the rotating shaft rotates, the slider can move linearly in the longitudinal direction of the second housing part.

In addition, according to the example embodiments of the invention, when the core part is inserted and combined in the first direction, the first fixing protrusion may be inserted and combined with the first combining slit. In addition, when the tension fixing portion is inserted into the third receiving portion in the second direction, the second fixing protrusion can be inserted into the second combining slit, and the rotational force providing part can rotate integrally with the second fixing part. Accordingly, when the door is rotated and the second fixing part rotates in conjunction with the door, the tension fixing part can be easily rotated in conjunction with the second fixing part.

It is to be understood that both the foregoing general description and the following detailed description are exemplary and explanatory and are intended to provide further explanation of the invention as claimed.

### BRIEF DESCRIPTION OF DRAWINGS

FIG. 1 is an example figure illustrating a door closer which is installed according to first example embodiment of the present invention;

FIG. 2 is a perspective view illustrating a first closer part of the door closer according to the first example embodiment of the present invention;

FIG. 3 is an exploded perspective view illustrating an example in which a first housing part and a rotational force providing part are combined with a first hinge part of the first closer part of the door closer according to the first embodiment of the present invention;

FIG. 4 is an exploded perspective view mainly illustrating the rotational force providing part of the first closer part of the door closer according to the first embodiment of the present invention;

FIG. 5 is an example cross-sectional view illustrating the first closer part of the door closer according to the first embodiment of the present invention;

FIG. 6 is a perspective view illustrating a second closer part of the door closer according to the first embodiment of the present invention;

FIG. 7 is an exploded perspective view illustrating an example in which a second housing part and a speed control part are combined with a second hinge part of the second closer part of the door closer according to the first embodiment of the present invention;

FIG. 8 is an exploded perspective view illustrating the second housing part and the speed control part of the second closer part of the door closer according to the first embodiment of the present invention;

FIG. 9 is a perspective view illustrating an adjusting part of the second closer part of the door closer according to the first embodiment of the present invention;

FIG. 10 is an exemplary view illustrating an operation example of the second closer part of the door closer according to the first embodiment of the present invention;

FIG. 11 is a perspective view illustrating a first closer part of a door closer according to a second embodiment of the present invention;

FIG. 12 is an exploded perspective view illustrating an example in which a first housing part and a rotational force providing part are combined with a first hinge part of the first closer part of the door closer according to the second embodiment of the present invention;

FIG. 13 is an exploded perspective view mainly illustrating the rotational force providing part of the first closer of the door closer according to the second embodiment of the present invention; and

FIG. 14 is an example cross-sectional view illustrating the first closer part of the door closer according to the second embodiment of the present invention.

### BEST EMBODIMENT OF THE INVENTION

Hereinafter, the invention will be explained in detail with reference to the accompanying drawings. The present invention may, however, be embodied in many different forms and should not be construed as limited to the example embodiments set forth herein and shown in accompanying drawings. In order to clearly illustrate the present invention, parts not related to the description are omitted, and the same reference numerals will be used to refer to the same or like parts throughout the specification.

Throughout the specification, when a part is referred to as being “connected” to another part, it includes not only “directly connected” but also “indirectly connected”. Also, when an element is referred to as “comprising”, it means that it can include other elements, not excluding other elements unless specifically stated otherwise.

Hereinafter, the example embodiment of the invention will be explained in detail with reference to the accompanying drawings.

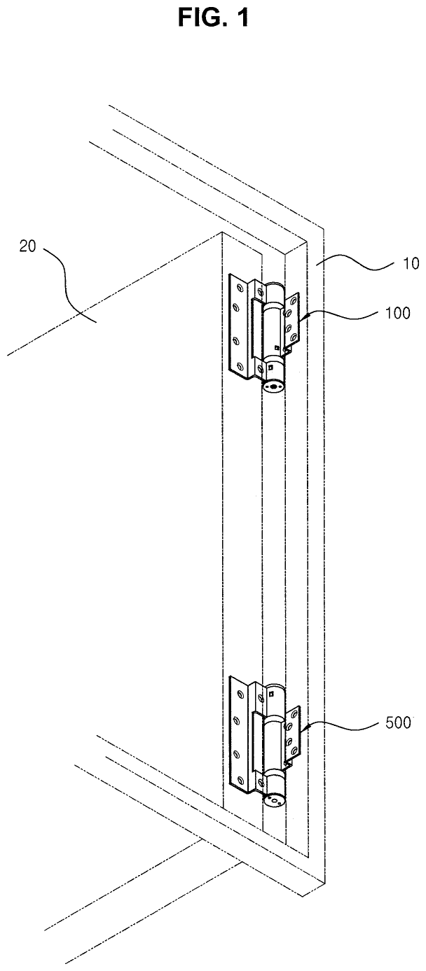

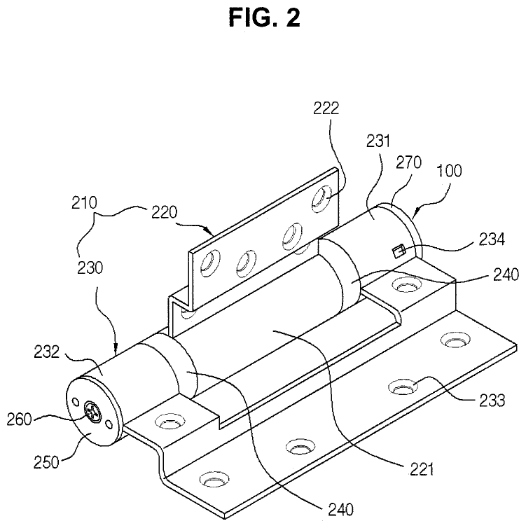

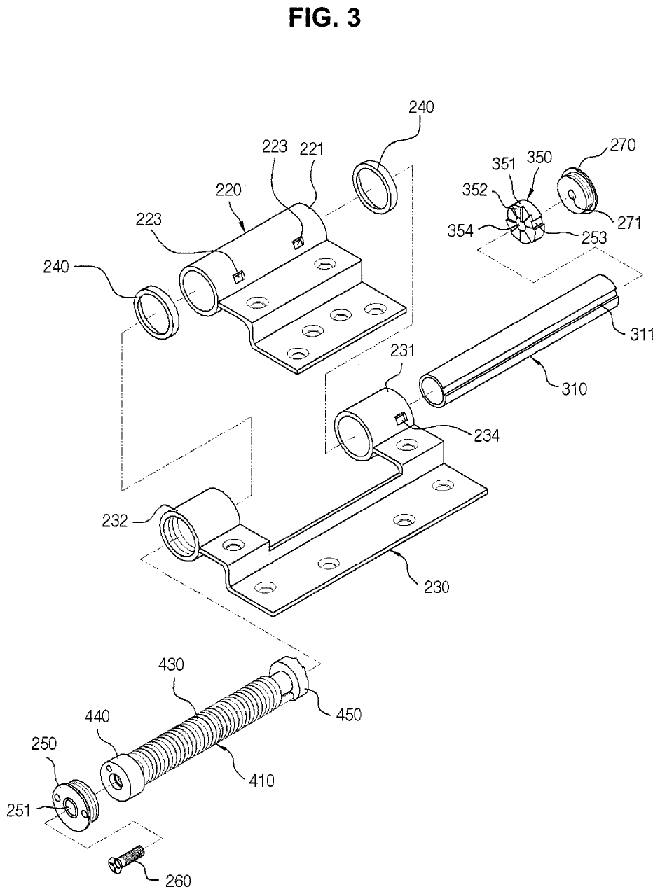

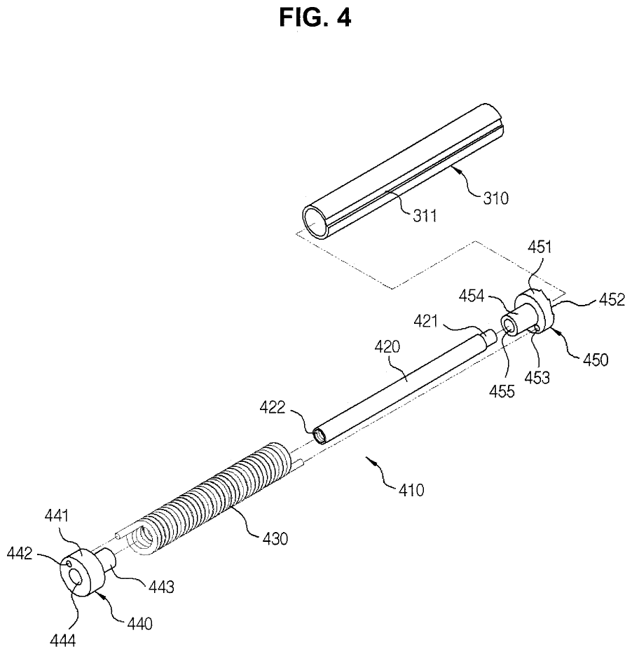

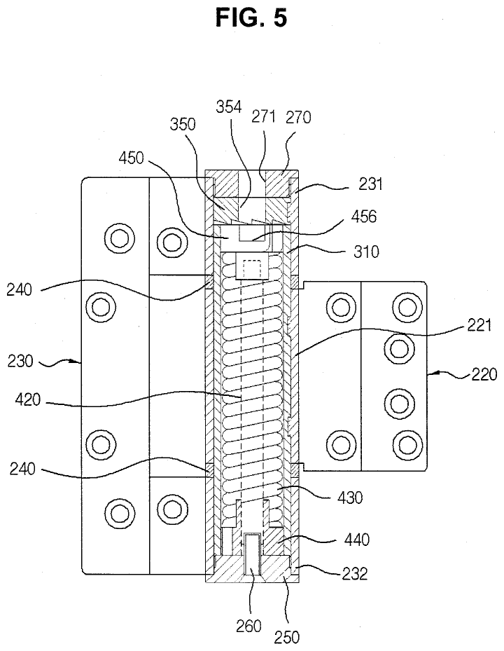

FIG. 1 is an example figure illustrating a door closer which is installed according to first example embodiment of the present invention. FIG. 2 is a perspective view illustrating a first closer part of the door closer according to the first example embodiment of the present invention. FIG. 3 is an exploded perspective view illustrating an example in which a first housing part and a rotational force providing part are combined with a first hinge part of the first closer part of the door closer according to the first embodiment of the present invention. FIG. 4 is an exploded perspective view mainly illustrating the rotational force providing part of the first closer part of the door closer according to the first embodiment of the present invention. FIG. 5 is an example cross-sectional view illustrating the first closer part of the door closer according to the first embodiment of the present invention.

Referring to FIGS. 1 to 5, the door closer may include a first closer part 100 and a second closer part 500. The first closer part 100 may be combined with a door frame 10 and a door 20 and may provide a rotational force in a direction in which the door 20 is closed. Accordingly, the door 20 can be closed automatically when a user opens the door 20 and releases his or her hand from the door 20.

The second closer part 500 may reduce a rotational speed of the door 20 by a damping force of a viscous fluid contained thereinside when the door 20 is closed by the first closer part 100. Accordingly, the door 20 can be prevented from being closed at a high speed, so that the door 20 can be prevented from being damaged and a safety accident can be prevented. The first closer part 100 and the second closer part 500 may be provided at an upper portion and a lower portion of the door 20, respectively.

Hereinafter, the first closer part 100 will be described in detail.

The first closer part 100 may include a first hinge part 210, a first housing part 310, a first ratchet part 350 and a rotational force providing part 410.

In addition, the first hinge part 210 may include a first fixing part 220 and a second fixing part 230.

The first fixing part 220 may have a first receiving portion 221 at a center thereof. The second fixing part 230 may include a second receiving portion 231 and a third receiving portion 232 which are spaced apart from each other.

The second receiving portion 231 and the third receiving portion 232 may be disposed at both ends of the first receiving portion 221, and may have same central axis. The first fixing part 220 and the second fixing part 230 may rotate about the axis of the first receiving portion 221, the second receiving portion 231 and the third receiving portion 232 in a hinge manner.

First combining holes 222 and 233 through which combining members (not shown) combined with the door frame 10 and the door 20 may be formed through the first fixing part 220 and the second fixing part 230. In the present example embodiment, the first fixing part 220 may be combined with the door frame 10 and the second fixing part 230 may be combined with the door 20.

In addition, a first insert ring 240 may be disposed between the first receiving portion 221 and the second receiving portion 231, and between the first receiving portion 221 and the third receiving portion 232, respectively.

The first housing part 310 may be disposed inside of the first receiving portion 221, the second receiving portion 231 and the third receiving portion 232, and serve as a rotating axis of the first fixing part 220 and the second fixing part 230.

The first housing part 310 may have a first combining slit 311 formed in the longitudinal direction of the first housing part 310. The first housing part 310 may be inserted into the third receiving portion 232 and combined with the second receiving portion 231 through the first receiving portion 221 along a first direction.

The first receiving portion 221 may have a first fixing protrusion 223 protruding inward. In addition, a plurality of the first fixing protrusions 223 may be formed along a longitudinal direction of the first receiving portion 221. Therefore, the first fixing protrusion 223 may be inserted into the first combining slit 311 when the first housing part 310 is inserted in the first direction, so that the first housing part 310 may rotate integrally with the first fixing part 220.

The first ratchet part 350 may be provided inside the second receiving portion 231.

The first ratchet part 350 may include a first ratchet body 351, a first ratchet 352, a second combining slit 353, and a first guiding hole 354.

The first ratchet body 351 may form a body of the first ratchet part 350. The first ratchet body 351 may have an outer diameter corresponding to an inner diameter of the second receiving portion 231.

The first ratchet 352 may be formed on one side of the first ratchet body 351 and opposite the first housing part 310. The first ratchet 352 may be formed along a circumferential direction.

The second combining slit 353 may be formed along a length direction of the first ratchet body 351 on an outer circumferential surface of the first ratchet body 351. A second fixing protrusion 234 protruding inward of the second receiving portion 231 may be inserted into a second combining slit 353.

The first ratchet part 350 may be inserted into the second receiving portion 231, so that the second fixing protrusion 234 is inserted into the second combining slit 353. Therefore, the first ratchet part 350 may be fixed to the second receiving portion 231.

The first guiding hole 354 may be formed through the first ratchet body 351 in a central axis direction.

The rotational force providing part 410 may include a guide shaft 420, a torsion spring 430, a tension fixing portion 440 and a second ratchet part 250.

The guide shaft 420 may be provided in a longitudinal direction of the first housing part 310 inside the first housing part 310.

A combining protrusion 421 may be formed at an end of the guide shaft 420. The combining protrusion 421 may be formed to have an outer diameter smaller than an outer diameter of the guide shaft 420. In addition, a first combining hole 422 may be formed along an axial direction at the other end of the guide shaft 420.

A screw thread may be formed in the first combining hole 422.

The torsion spring 430 may be provided in a length direction of the guide shaft 420 to surround the guide shaft 420. The torsion spring 430 may be a coil spring formed to be wound in one direction.

The tension fixing portion 440 may be inserted into one end of the first housing part 310. In addition, the tension fixing portion 440 may be fixed to the first housing part 310. For this, the tension fixing portion 440 may be combined in an interference fit manner or welded to the first housing part 310.

The tension fixing portion 440 may include a fixing body 441, a first extending protrusion 443 and a first insert hole 444.

The fixing body 441 may be combined with an end of the first housing part 310. A first fixing hole 442 may be formed at the fixing body 441 along the axial direction, and an end of the torsion spring 430 may be inserted into and fixed to the first fixing hole 442.

The first extending protrusion 443 may be protruded from a surface of the fixing body 441 along a length direction of the tension fixing portion 440. The first extending protrusion 443 may be inserted into inside of the torsion spring 430.

As an end of the torsion spring 430 is fixed to the first fixing hole 442, and the first extending protrusion 443 is inserted into the inside of the torsion spring 430, the torsion spring 430 and the tension fixing portion 440 may be stably combined with each other.

The first insert hole 444 may be formed through the fixing body 441 and the first extending protrusion 443 in a central axis direction of the tension fixing portion 440. The first insert hole 444 may have an inner diameter larger than an outer diameter of the guide shaft 420. Accordingly, the guide shaft 420 may be reciprocated in a longitudinal direction of the first housing part 310 while being inserted into the first insertion hole 444.

Since the tension fixing portion 440 is fixed to the first housing part 310, it can be rotated integrally with the first housing part 310. In addition, the tension fixing portion 440 may be fixed to the first housing part 310 to fix one end of the torsion spring 430.

A second ratchet part 450 may include a second ratchet body 451, a second ratchet 452, a second extending protrusion 454 and a second guide hole 456.

The second ratchet body 451 may form a body of the second ratchet part 450. The second ratchet body 451 may have an outer diameter corresponding to an inner diameter of the first housing part 310. A second fixing groove 453 in which the other end of the torsion spring 430 is combined may be formed at the second ratchet body 451.

The second ratchet 452 may be formed at a surface of the second ratchet body 451 to face the first ratchet 352. The second ratchet 452 may be formed along a circumferential direction, and may be combined with the first ratchet 352 in a ratchet manner. The second ratchet 452 may be ratchet-engaged with the first ratchet part 350 to rotate only in one direction and may be constrained not to rotate in the other direction.

The second extending protrusion 454 may be formed on the other surface of the second ratchet body 451. A second insert hole 455 may be formed in the second extending protrusion 454, and the combining protrusion 421 of the guide shaft 420 may be inserted into the second insert hole 455. The combining protrusion 421 may be combined in an interference fit manner or welded to the second insert hole 455, so that the second ratchet part 450 and the guide shaft 420 can be rotated integrally with each other.

Since the first fixing part 220 is fixed to the door frame 10, the first housing part 310 fixed to the first receiving portion 221 and the tension fixing portion 440 fixed to the first housing part 310 may maintain a fixed state. When the door 20 rotates, the second fixing part 230 rotates in conjunction with the door 20, and the first ratchet part 350 combined with the second receiving portion 231 rotates in conjunction therewith. And, when the first ratchet part 350 rotates, the second ratchet part 450 combined therewith in a ratchet manner. As the second ratchet part 450 rotates, the torsion spring 430 deforms to generate an elastic restoring force. The elastic restoring force generated from the torsion spring 430 may be applied in a direction in which the door 20 is closed so that the door 20 may rotate in the closing direction when the user releases the door 20.

Here, the second ratchet portion 450 may be rotated only in a direction in which the torsion spring 430 is wound while the first ratchet part 350 and the second ratchet part 450 are combined with each other. In other word, in a state where the first ratchet part 350 and the second ratchet part 450 are engaged with each other, rotation of the second ratchet part 450 is restricted by the first ratchet part 350 so that the torsion spring 430 is not rotated in an opposite direction of the winding direction.

Thus, when the second fixing part 230 rotates with the door 20 while the door 20 rotates in opening direction, the first ratchet part 350 rotates together. Here, the first ratchet part 350 rotates in the opposite direction of the winding direction of the torsion spring 430 and the second ratchet part 450 rotates together with the first ratchet part 350 in a ratchet state.

Accordingly, the torsion spring 430 is expanded in the opposite direction of the winding direction and becomes larger in a radial direction. However, since an inner space of the first housing part 310 is limited in size, the torsion spring 430 is extended along the longitudinal direction after that. And then, as the length of the torsion spring 430 increases, the torsion spring 430 elastically supports the second ratchet part 450 toward the first ratchet part 350, so that the second ratchet part 450 can be continuously and reliably combined with the first ratchet part 350 in the ratchet manner.

A second guide hole 456 may be formed at a center of the one surface of the second ratchet body 451. The second guide hole 456 may be connected to the first guide hole 354 of the first ratchet part 350.

The second guide hole 456 may have an axial cross-sectional shape of a hexagonal shape through which a hexagonal wrench can be engaged. The hexagonal wrench may be inserted through the first guide hole 354 and engaged to the second guide hole 456. The user can rotate the second ratchet part 450 by using the hexagonal wrench, whereby a degree of winding of the torsion spring 430 can be adjusted.

Thus, in a state where the first ratchet part 350 is fixed, the user can rotate the second ratchet part 450 in a direction in which the torsion spring 430 is wound. When the second ratchet part 450 rotates, click sound may be generated between the second ratchet 452 and the first ratchet 352. According to this, the user can recognize amount of rotation of the second ratchet part 450 and also know rotation angle of the second ratchet part 450. The user can adjust a magnitude of the elastic restoring force generated by the torsion spring 430 by adjusting an amount of rotation of the second ratchet part 450, so that speed rotation of the door in the closing direction can be adjusted.

In addition, a pressing tool may be inserted into the second guide hole 456 through the first guide hole 354, and the second ratchet part 450 may be pressed by using the pressing tool, so that ratchet-combination of the second ratchet part 450 and the first ratchet part 350 may be released. Thus, a degree of twist of the torsion spring 430 can be returned to the initial state.

The rotational force providing part 410 may include a first cap 250, an adjustment bolt 260, and a second cap 270.

The first cap 250 may be combined with the third receiving portion 232. The first cap 250 may be combined with and removed from the third receiving portion 232 by a screw connection. A third insert hole 251 may be formed at the first cap 250 in a central axis direction, and the third insert hole 251 may be connected to the first insert hole 444 of the tension fixing portion 440.

The adjustment bolt 260 may be inserted through the third insert hole 251 and combined with the first combining hole 422 of the guide shaft 420 by a screw connection. When the adjustment bolt 260 rotates and is tightened in the first combining hole 422 in a state where the first cap 250 and the tension fixing portion 440 are in close contact with each other, the guide shaft 420 may be moved toward the adjustment bolt 260. Here, the torsion spring 430 may be compressed, and the ratchet-combination of the first ratchet part 350 with the second ratchet part 450 may be released. Thus, a rotation restoring force by the torsion spring 430 is not generated. After the door 20 is rotated to open, the door 20 is not rotated in the closing direction even if the user does not hold the door 20.

However, when the adjustment bolt 260 is rotated and released in the first combining hole 422, the guide shaft 420 is moved in an opposite direction of the adjustment bolt 260 and the second ratchet part 450 is combined with the first ratchet part 350 in the ratchet manner, so that the elastic restoring force of the torsion spring 430 can be generated.

The second cap 270 may be combined with the second receiving portion 231. The second cap 270 may be combined with and removed from the second receiving portion 231 by a screw connection. The second cap 270 may have a third guide hole 271 formed in the central axis direction. The third guide hole 271 may be connected to the first guide hole 354 of the first ratchet part 350. Above mentioned wrench may be inserted through the third guide hole 271.

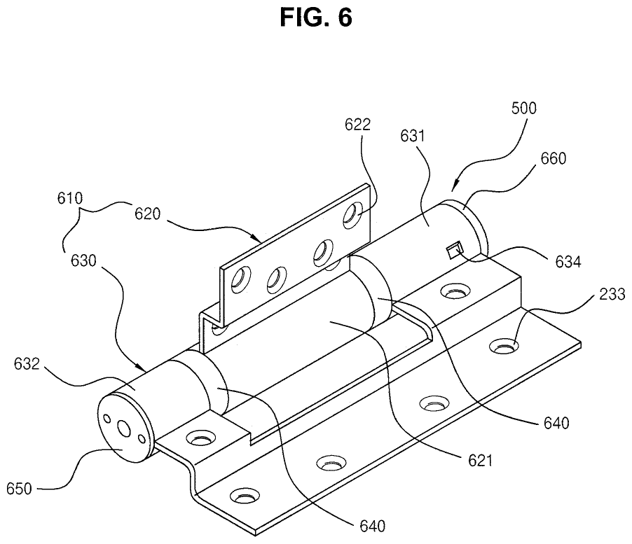

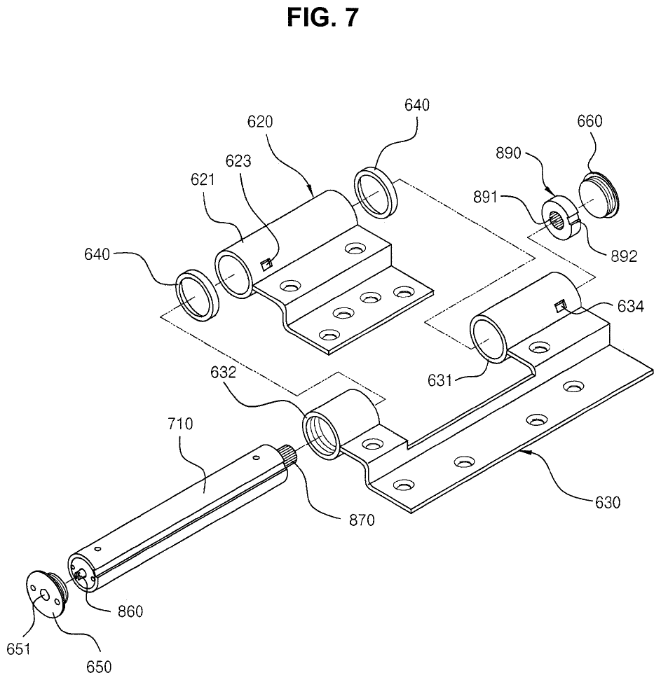

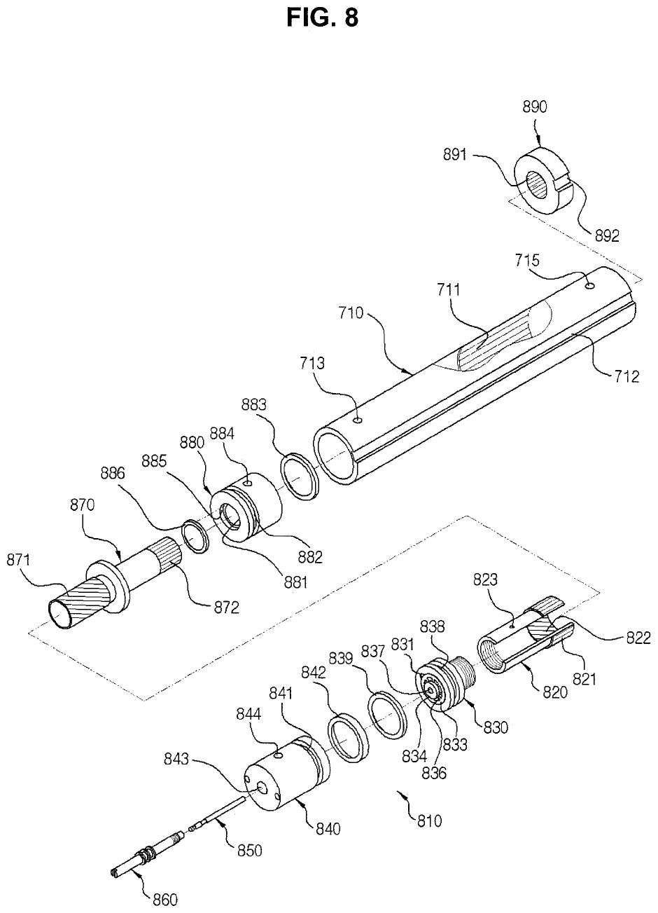

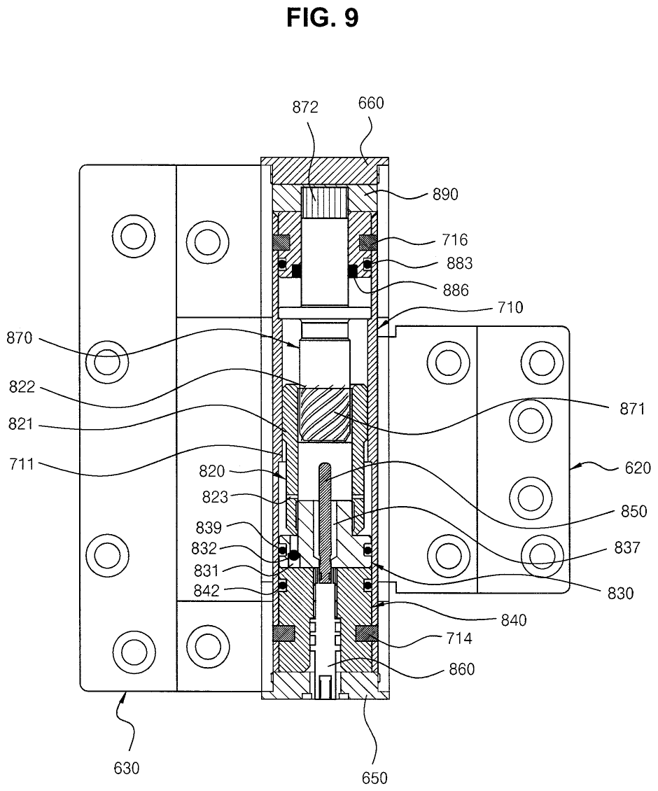

FIG. 6 is a perspective view illustrating a second closer part of the door closer according to the first embodiment of the present invention. FIG. 7 is an exploded perspective view illustrating an example in which a second housing part and a speed control part are combined with a second hinge part of the second closer part of the door closer according to the first embodiment of the present invention. FIG. 8 is an exploded perspective view illustrating the second housing part and the speed control part of the second closer part of the door closer according to the first embodiment of the present invention. FIG. 9 is a perspective view illustrating an adjusting part of the second closer part of the door closer according to the first embodiment of the present invention.

As shown in FIGS. 6 to 9, the second closer part 500 may include a second hinge part 610, a second housing part 710 and a speed control part 810.

The second hinge part 610 may include a third fixing part 620 and a fourth fixing part 630. The third fixing part 620 may have a fourth receiving portion 621 in the middle thereof. The fourth fixing part 630 may include a fifth receiving portion 651 and sixth receiving portion 632 which are spaced apart from each other. The fifth receiving portion 631 and the sixth receiving portion 632 may be disposed at both ends of the fourth receiving portion 621. Thus, the third fixing part 620 and the fourth fixing part 630 may rotate about the axis of the fourth, fifth and sixth re receiving portions 621,631 and 632 in a hinge manner.

The second combining holes 622 and 633 may be respectively formed in the third fixing part 620 and the fourth fixing part 630 to be combined with a combining member (not shown) which is combined to the door frame 10 and the door 20. In the present example embodiment, the third fixing part 620 may be combined with the door frame 10, and the fourth fixing part 630 may be combined with the door 20. A second insert ring 640 may further be provided between the fourth receiving portion 621 and the fifth receiving portion 631 and between the fourth receiving portion 621 and the fifth receiving portion 631.

The second housing part 710 may be disposed inside of the fourth receiving portion 621, the fifth receiving portion 631 and the sixth receiving portion 63, and may serve as a rotating axis of the third fixing part 620 and the fourth fixing part 630. The second housing part 710 may be formed in a cylindrical shape, so that the speed control part 810 may be received in the second housing part 710.

In addition, the first guide part 711 in a longitudinal direction may be formed on an inner circumferential surface of the second housing part 710. The first guide part 711 may be a serration.

In addition, a third combining slit 712 may be formed on an outer circumferential surface of the second housing part 710 in the longitudinal direction of the second housing part 710. The second housing part 710 may be inserted in the fourth, fifth and sixth receiving portions 621,631 and 632. A third fixing protrusion 623 may protrude inward from the fourth receiving portion 621. When the second housing part 710 may be inserted into the fourth housing part 621, the third fixing slit 712 may be inserted into the third housing part 710, so that the second housing part 710 may rotate integrally with the third fixing part 620.

The speed control part 810 may include a slider 820, an adjusting part 830, a first capping part 840, a control bar 850, an adjustment part 860, a rotating shaft part 870, a second capping part 880 and an shaft fixing part 890.

First, a second guide portion 821 combined with the first guide portion 711 may be formed on an outer circumferential surface of the slider 820. The second guide portion 821 may be a serration paired with the first guide portion 711. Accordingly, the slider 820 can move in a length direction of the second housing part 710 in the second housing part 710. In addition, a third guide portion 882 may be formed may be formed on an inner circumferential surface of the slider 820. Here, the third guide portion 822 may be formed in a spiral shape. In this embodiment, the third guide portion 822 may be a helical gear. In addition, the slider 820 may be formed with a first flow hole 823 through which a viscous fluid (not shown) can move from inner side to outer side of the slider 820.

The adjusting part 830 may be combined with one end of the slider 820. A second flow hole 831 may be formed through the adjusting part 830 in a longitudinal direction of the adjusting part 830. The second flow hole 831 may have a compressed tube portion and expanded tube portion and may be formed in the axial direction of the slider 820. A check ball 832 may be provided inside of the second flow hole 831. A diameter of the check ball 832 may be larger than a diameter of the compressed tube portion of the second flow hole 831, and smaller than a diameter of the expanded tube portion.

The expanded tube portion of the second flow hole 831 may penetrate a surface of the adjusting part 830, and the compressed tube portion of the second flow hole 831 may penetrate the other surface of the adjusting part 830. In addition, a cover ring 833 may be provided at the surface of the adjusting part 830. The cover ring 833 may have a hook 836 combined with a combining groove 835 formed along a circumferential direction at a combining portion 834 provided on the surface of the adjusting part 830. The cover ring 833 may be provided to cover at least a portion of the expanded tube portion of the second flow hole 831 to prevent the check ball 832 from being discharged to the expanded tube portion of the second flow hole 831.

A third flow hole 837 may be formed through a center of the adjusting part 830 in the axial direction. The third flow hole 837 may have a first diameter.

In addition, a first ring groove 838 may be formed in a circumferential direction on an outer circumferential surface of the adjusting part 830. A first sealing member 839 may be provided in the first ring groove 838. The first sealing member 839 may be in close contact with the inner circumferential surface of the second housing part 710 to block movement of the viscous fluid received inside the second housing part 710.

The first capping part 840 may be combined to inside of one end of the second housing part 710 to seal the one end of the second housing part 710. A second ring groove 841 may be formed at the first capping part 840 along a circumferential direction, and a second sealing member 842 may be provided in the second ring groove 841 to prevent leakage of the viscous fluid from the second housing part 710.

In addition, a first combining opening 843 is formed in the middle of the first capping part 840 therethrough. In addition, the adjustment part 860 may be provided in the first combining opening 843. The adjustment part 860 may be combined with first combining opening 843 by a screw connection, and may be provided to reciprocate in a longitudinal direction of the first capping part 840.

In addition, at least one first pin groove 844 may be formed at the first capping part 840. The first pin groove 844 may be formed to correspond to a first pin hole 713 formed at the second housing part 710, As a first pin 714 is combined with the first pin hole 713 and the first pin groove 844, the first capping part 840 may be fixed to the second housing part 710.

The control bar 850 may be combined with the adjustment part 860, may be provide to be exposed outside of the first capping part 840, and may be inserted into the third flow hole 837 of the adjusting part 830. The control bar 850 may have a second diameter that is less than the first diameter of the third flow hole 837. Thus, the control bar 850 may be provided such that its outer peripheral surface is spaced from an inner peripheral surface of the third flow hole 837. The control bar 850 can be adjusted in protrusion length by the adjustment part 860.

A fourth guide portion 871 combined with the third guide part 822 may be formed on an outer circumferential surface of one end of the rotating shaft part 870 may be formed. The fourth guide portion 871 may be formed in a shape corresponding to the third guide portion 822. In addition, a fifth guide portion 872 may be formed on the outer circumferential surface of the other end of the rotating shaft part 870 in a longitudinal direction of the rotating shaft part 870. The fifth guide portion 872 may be a serration. The fifth guide portion 872 may extend outside the second housing part 710.

A first through hole 881 may be formed in the second capping part 880 in the axial direction, and the first through hole 881 may be combined with to the rotating shaft part 870. The second cap part 880 may be disposed inside the other end of the second housing portion 710. A third ring groove 882 may be formed at the second capping part 880 along a circumferential direction, and a third sealing member 883 may be provided in the third ring groove 882 to prevent leakage of the viscous fluid from the second housing part 710.

In addition, at least one second pin groove 884 may be formed at the second capping part 880. The second pin groove 884 may be formed to correspond to a second pin hole 715 formed at the second housing part 710, As a second pin 716 is combined with the second pin hole 715 and the second pin groove 884, the second capping part 880 may be fixed to the second housing part 710.

In addition, a fourth ring groove 885 may be formed along the circumferential direction on an inner peripheral surface of the second capping part 880, and a fourth sealing member 886 may be provided in the fourth ring groove 885 to prevent leakage of the viscous fluid between the rotating shaft part 870 and the second capping part 880. The fourth sealing member 886 may be a quadring.

A sixth guide portion 891 may be formed on an inner circumferential surface of the shaft fixing part 890 which is combined with the fifth guide portion 872. The sixth guide portion 891 may be a serration paired with the fifth guide portion 872. The shaft fixing part 890 can be combined with the fifth guide portion 872 of the rotating shaft part 870 outside the second housing portion 710. Here, the shaft fixing part 890 may be disposed at the fifth receiving portion 631.

A fourth fixing protrusion 634 may protrude inward from the fifth receiving portion 631 and a fourth combining slit 892 may be formed on the outer circumferential surface of the shaft fixing part 890. The fourth combining slit 892 may be formed in a longitudinal direction of the shaft fixing part 890 so that the fourth fixing protrusion 634 is inserted and combined when the shaft fixing part 890 is inserted into the fifth receiving portion 631.

Accordingly, when the fourth fixing part 630 rotates, the shaft fixing part 890 also rotates together and can transmit the rotational force to the rotating shaft part 870. As the rotating shaft part 870 rotates, the slider 820 can move linearly in the longitudinal direction of the second housing part 710.

A third cap 650 may be combined with the sixth receiving portion 632, and a fourth cap 660 may be combined to the fifth receiving portion 631. The third cap 650 may be combined with the sixth receiving portion 632 by a screw connection. The fourth cap 660 may be combined with the fifth receiving portion 631 in a screw connection. A second through hole 651 may be formed in the third cap 650 so that the adjustment part 860 penetrates and is exposed outside.

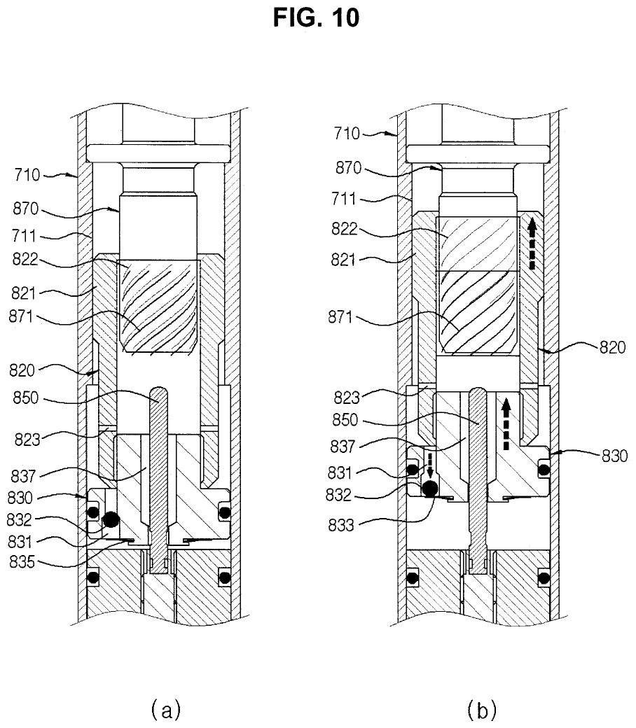

FIG. 10 is an exemplary view illustrating an operation example of the second closer part of the door closer according to the first embodiment of the present invention. FIG. 10 (a) shows the speed control part 810 when the door is closed, and FIG. 10 (b) shows the speed control part 810 when the door is open.

Referring to FIGS. 10 (a) and (b), when the closed door is rotated to open, the fourth fixing part 630 combined to the door 20 is rotated, and thus the shaft fixing part 890 combined with the fourth fixing part 630 is rotated. And then, when the shaft fixing part 890 is rotated, the rotating shaft part 870 serration-combined with the shaft fixing part 890 is also rotated together. In addition, since the third fixing part 620 combined with the door frame is in a fixed state, the second housing part 710 combined with the third fixing part 620 and the slider 82 serration-combined with the second housing part 710 maintain a non-rotating state. However, as the rotating shaft part 870 rotates, the rotational force of the rotating shaft part 870 is transmitted to the slider 820, and then the slider 820 moves linearly. In the example embodiment, when the door 20 is rotated to open, the slider 820 moves upward. On the other hand, the space between the first capping part 840 and the second capping part 880 inside the second housing part 710 is filled with a viscous fluid. The viscous fluid may be filled both inside and outside of the slider 820 through the first flow hole 823 of the slider 820. Accordingly, when the slider 820 is moved upward, the viscous fluid between the adjustment part 830 and the second capping part 880 is pressed so that the viscous fluid can move through the second flow hole 831 of the adjustment part 830. Here, since the second flow hole 831 is formed to extend downward, flow of the viscous fluid is not clogged by the check ball 832 and the viscous fluid can be moved without resistance. In this case, the viscous fluid can also move through the gap between the third flow hole 837 of the adjustment part 830 and the control bar 850. Accordingly, when the door 20 is opened, the flow resistance of the viscous fluid is low and the door 20 can rotate so that the door 20 opens relatively quickly.

In addition, when the opened door 20 is rotated in the closing direction, the rotation direction of the rotating axis 870 is reversed, and the slider 820 moves downward. In this case, the viscous fluid between the adjustment part 830 and the first capping part 840 is compressed, and then the check ball 832 of the second flow hole 831 of the adjustment part 830 is moved upward by the pressure of the viscous fluid and blocks the second flow hole 831 so that the viscous fluid cannot be moved. Therefore, in this case, the viscous fluid can only be moved through the gap between the third flow hole 837 and the control bar 850, and this increases the flow resistance of the viscous fluid, i.e., the damping force is increased, so that closing speed of the door 20 is reduced.

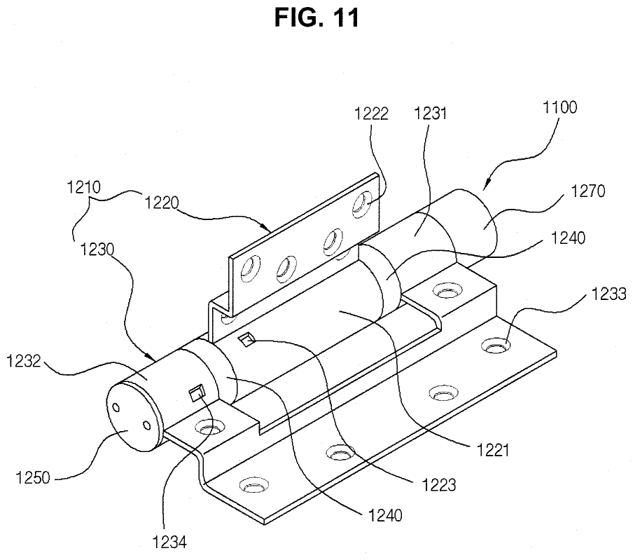

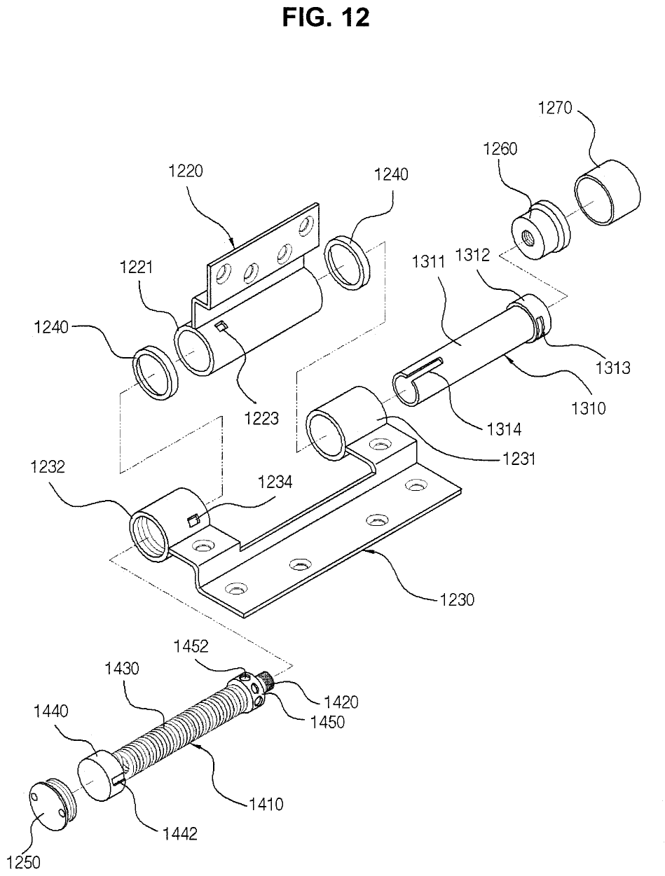

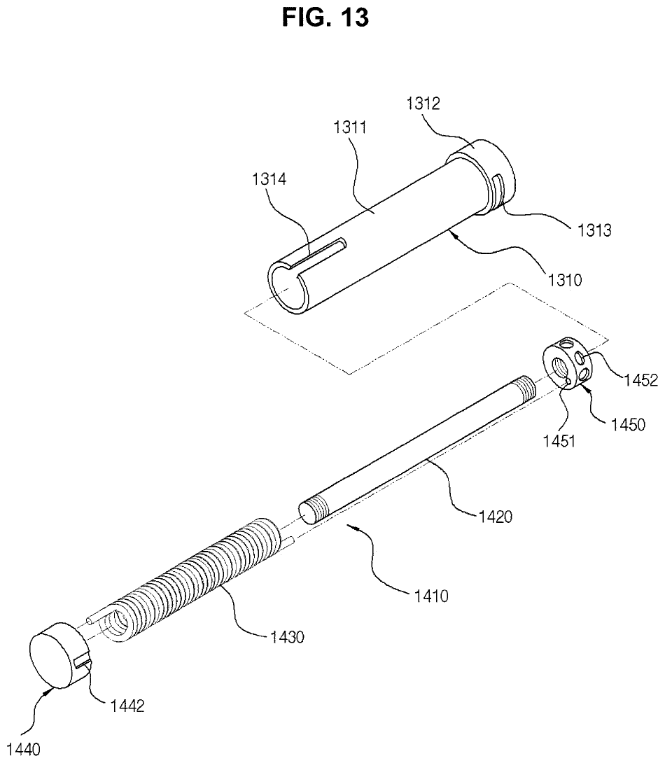

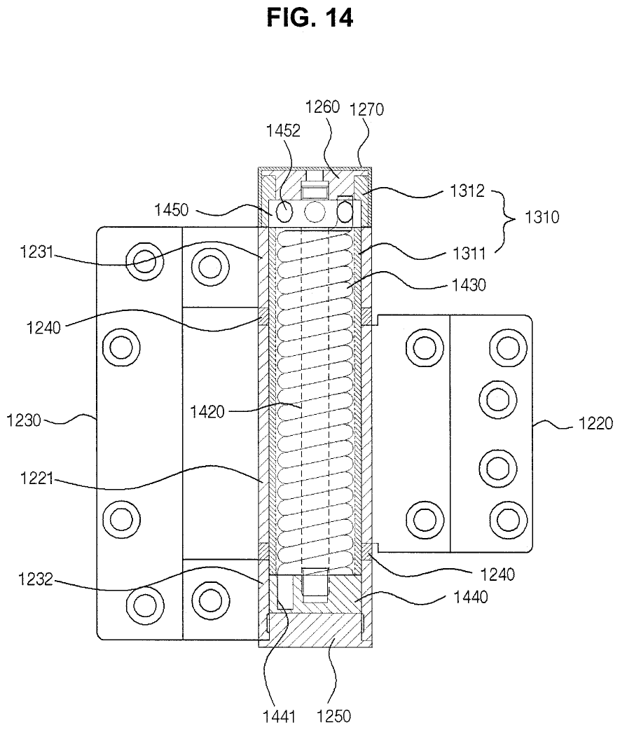

FIG. 11 is a perspective view illustrating a first closer part of a door closer according to a second embodiment of the present invention. FIG. 12 is an exploded perspective view illustrating an example in which a first housing part and a rotational force providing part are combined with a first hinge part of the first closer part of the door closer according to the second embodiment of the present invention. FIG. 13 is an exploded perspective view mainly illustrating the rotational force providing part of the first closer of the door closer according to the second embodiment of the present invention. FIG. 14 is an example cross-sectional view illustrating the first closer part of the door closer according to the second embodiment of the present invention.

Referring to FIGS. 11 to 14, the first closer part 1100 may include a first hinge part 1210, a first housing part 1310, and a rotational force providing part 1410.

In addition, the first hinge part 1210 may include a first fixing part 1220 and a second fixing part 1230. The first fixing part 1220 may have a first receiving portion 1221 at a center thereof. The second fixing part 1230 may include a second receiving portion 1231 and a third receiving portion 1232 which are spaced apart from each other. The second receiving portion 1231 and the third receiving portion 1232 may be disposed at both ends of the first receiving portion 1221. The first fixing part 1220 and the second fixing part 1230 may rotate about the axis of the first receiving portion 1221, the second receiving portion 1231 and the third receiving portion 1232 in a hinge manner.

First combining holes 1222 and 1233 through which combining members (not shown) combined with the door frame 10 and the door 20 may be formed through the first fixing part 1220 and the second fixing part 1230. In the present example embodiment, the first fixing part 1220 may be combined with the door frame 10 and the second fixing part 1230 may be combined with the door 20. A first insert ring 1240 may be disposed between the first receiving portion 1221 and the second receiving portion 1231, and between the first receiving portion 1221 and the third receiving portion 1232, respectively.

The first housing part 1310 may include a core part 1311 and a head portion 1312. The core portion may be disposed inside of the first receiving portion 1221, the second receiving portion 1231 and the third receiving portion 1232, and serve as a rotating axis of the first fixing part 1220 and the second fixing part 1230.

The head portion 1312 may be formed at one end of the core portion 1311. The head portion 1312 may be formed to extend outwardly of the second receiving portion 1231 when the first housing portion 1310 is combined with the first hinge part 1210. The head portion 1312 may be provided with an adjusting slit 1313 in a circumferential direction.

The core portion 1311 and the head portion 1312 may be formed in a cylindrical shape. Accordingly, the rotational force providing part 1410 may be provided inside the first housing part 1310.

In addition, a first combining slit 1314 may be formed at the other end of the core portion 1311 in the longitudinal direction of the core portion 1311. The core portion 1311 may be inserted into the second receiving portion 1231 and combined in a direction toward the first receiving portion 1221 (the first direction). The first receiving portion 1221 may have a first fixing protrusion 1223 protruded inward. Accordingly, when the core portion 1311 is inserted and combined in the first direction, the first fixing protrusion 1223 can be inserted into the first combining slit 1314. Accordingly, the first housing part 1310 can rotate integrally with the first fixing part 1220.

The rotation force providing part 1410 may have a guide shaft 1420, a torsion spring 1430, a tension fixing part 1440, and a tension adjusting part 1450.

The guide shaft 1420 may be provided in the longitudinal direction of the core portion 1311 on the inner side of the core portion 1311.

The torsion spring 1430 may be provided in the longitudinal direction of the guide shaft 1420 while surrounding the guide shaft 1420.

The tension fixing part 1440 may be provided at one end of the guide shaft 1420. The tension fixing part 1440 can be combined with the one end of the guide shaft 1420 by a screw connection. A first fixing groove 1441 may be formed in the tension fixing part 1440, and an end of the torsion spring 1430 may be combined with the first fixing groove 1441. The tension fixing part 1440 may be combined with the third receiving portion 1232. Here, a second fixing protrusion 1234 may protrude inward from the third receiving portion 1232. A second combining slit 1442 may be formed on the outer peripheral surface of the tension fixing part 1440 in the longitudinal direction of the tension fixing part 1440. The rotation force providing part 1410 may be inserted into the first housing portion 1310 in a second direction which is opposite to the first direction. That is, in a state in which the first housing part 1310 is inserted into the first and second receiving portions 1221 and 1231 in the first direction, the rotation force providing part 1410 may be inserted into the first housing part 1310 in the second direction. When the tension fixing part 1440 is inserted into the third receiving portion 1232 in the second direction, the second fixing protrusion 1234 can be inserted into the second combining slit 1442. Accordingly, the rotation force providing part 1410 can rotate integrally with the second fixing part 1230. Accordingly, when the door 20 rotates and the second fixing part 1230 rotates in conjunction with the door 20, the tension fixing part 1440 rotates in conjunction therewith.

The tension adjusting part 1450 may be provided at the other end of the guide shaft 1420. The tension adjusting part 1450 may be combined with the other end of the guide shaft 1420 by a screw connection. The tension adjusting part 1450 may have a second fixing groove 1451, and the other end of the torsion spring 1430 may be combined with the second fixing groove 1451. The tension adjusting part 1450 may be received in the head portion 1312. In addition, the adjusting groove 1452 may be formed on the outer circumferential surface of the tension adjusting part 1450 to be exposed through the adjusting slit 1313. A plurality of the adjusting grooves 1452 may be formed at predetermined intervals along the circumferential direction of the tension adjusting part 1450. An adjustment pin (not shown) may be combined with the adjustment groove 1452 from the outside through the adjustment slit 1313. The adjustment pin may be configured to fix the tension adjusting part 1450 to the head part 1312. Accordingly, the tension adjusting part 1450 may be rotate in conjunction with the first housing part 1310.

The rotation force providing part 1410 may provide a rotational force to rotate the door 20 in the closing direction. That is, when the door 20 is rotated in the opening direction, the second fixing part 1230 rotates together with the door 20, and the tension fixing part 1440 rotates in conjunction therewith. Here, since the first housing part 1310 combined with the first fixing part 1220 does not rotate, the tension adjusting part 1450 does not rotate. Accordingly, the torsion spring 1430 is wound and a torsional elastic force is generated. And then, when the user releases the door 20, the door 20 may be rotated in the closing direction by the restoring force of the torsion spring 1430.

A first cap 1250 may be combined with the third receiving portion 1232 and a second cap 1260 may be combined with the second receiving portion 1231. The first cap 1250 may be combined with the third receiving portion 1232 by a screw connection. The second cap 1260 may be combined with the third receiving portion 1232 by a screw connection. The head portion 1312 may further include a cover 1270 covering the head portion 1312 and the second cap 1260.

The foregoing description of the present invention is intended to be illustrative, and it will be understood by those skilled in the art that various changes in form and details may be made therein without departing from the spirit and scope of the invention as defined by the appended claims. It is therefore to be understood that the above-described embodiments are illustrative in all aspects and not restrictive. For example, each component described as a single entity may be distributed and implemented, and components described as being distributed may also be implemented in a combined form.

Although the embodiments of the invention have been shown and described, it will be apparent to those skilled in the art that various changes and modifications may be made without departing from the scope of the invention as defined by the appended claims.

1. A door closer, comprising:
a first closer part combined with a doorframe and a door to provide a rotational force in a direction in which the door is closed; and
a second closer part to reduce a rotational speed of the door by a damping force of a viscous fluid contained thereinside when the door is closed by the first closer part.

2. The door closer of claim 1, wherein the first closer part comprises:
a first fixing part comprising a first receiving portion;
a second fixing part comprising a second receiving portion and a third receiving portion which are disposed at both ends of the first receiving portion to hinge-rotate with the first fixing part;
a first housing part disposed inside of the first receiving portion, the second receiving portion and the third receiving portion to combine the first fixing part with the second first fixing part, and having a cylindrical shape;
a first ratchet part fixed inside of the second receiving portion; and
a rotational force providing part disposed inside of the first housing part, wherein one end of the rotational force providing part is combined with the first housing part, and another end of the rotational force providing part is ratchet-combined with the first ratchet part and provides a rotational force by a torsional elastic force to the second fixing part.

3. The door closer of claim 2, wherein the first receiving portion has a first fixing protrusion protruding inward, and
a first combining slit is formed along a length direction of the first housing part at the first housing part to receive the first fixing protrusion when the first housing part is inserted into the first receiving portion in a first direction.

4. The door closer of claim 2, wherein the rotational force providing part comprises:
a guide shaft provided in a longitudinal direction of the first housing part in the first housing part, and having a combining protrusion at an end thereof and a first combining hole in an axial direction at the other end thereof;
a torsion spring provided in a length direction of the guide shaft to surround the guide shaft;
a tension fixing portion comprising:
a fixing body combined with an end of the first housing part, a fixing groove being formed thereof to be combined with an end of the torsion spring;
a first extending protrusion protruded from a surface of the fixing body and inserted into the torsion spring; and
a first insert hole formed through the fixing body and the first extending protrusion along a central axis direction, an end of the guide shaft being inserted into the first insert hole so that the guide shaft reciprocate in a axial direction of the first housing part;
a second ratchet part combined with the other end of the guide shaft, combined with the other end of the torsion spring, and combined with the first ratchet part in a ratchet manner.

5. The door closer of claim 4, wherein
the first ratchet part comprises:
a first ratchet body;
a second combining slit formed on an outer circumferential surface of the first ratchet body so that a second fixing protrusion which protrudes inside of the second receiving portion is inserted thereinto;
a first ratchet formed along a circumferential direction on one surface of the first ratchet body to face the first housing part; and
a guiding hole formed through first ratchet body in a central axis direction, and
the second ratchet part comprises:
a second ratchet body on which a second fixing groove is formed to be combined with the other end of the torsion spring;
a second ratchet formed on one surface of the second ratchet body to face the first ratchet to be combined with the first ratchet in a ratchet manner;
a second extending portion formed on the other surface of the second ratchet body through which a second insert hole is formed; and
a second guide hole formed at a center of the one surface of the second ratchet body and connected to the first guiding hole,
wherein in a state where the first ratchet part and the second ratchet part are engaged with each other, rotation of the second ratchet part is restricted by the first ratchet part so that the torsion spring is not rotated in an opposite direction of the winding direction, and the second ratchet part rotates only in a direction in which the torsion spring is wound.

6. The door closer of claim 5, wherein the rotational force providing part comprises:
a first cap combined with the third receiving portion and having a third insert hole in a central axis direction to be connected to the first insert hole;
an adjustment bolt inserted through the third insert hole, combined with the first combining hole by a screw connection, and being for selectively ratchet-combining the second ratchet part and the first ratchet by reciprocating the guide shaft in the longitudinal direction of the first housing part while rotating;
a second cap combined with inside of the second receiving portion, and having a third guide hole formed in the central axis direction to be connected with the first guide hole.

7. The door closer of claim 1, wherein the second closer part comprises:
a second hinge part comprising a third fixing part comprising a fourth receiving portion, and a fourth fixing part comprising a fifth receiving portion and a sixth receiving portion disposed at both ends of the fourth receiving portion to rotate with the third fixing part in a hinge manner;
a second housing part disposed inside of the fourth receiving portion, the fifth receiving portion and the sixth receiving portion, and having a first guide part formed in a longitudinal direction on an inner circumferential surface of the second housing part; and
a speed control part provide inside of the second housing part, wherein a portion of speed control part is combined with the second housing part, the other portion of speed control part is combined with the fifth housing part, and the speed control part reduce a rotational speed of the fourth fixing part by a damping force of a viscous fluid contained thereinside.

8. The door closer of claim 7, wherein a third fixing protrusion is protruded inside of the fourth receiving portion, and
a third combining slit is formed on an outer circumferential surface of the second housing part in the longitudinal direction of the second housing part to receive the third fixing protrusion when the second housing part is inserted into the fourth receiving portion.

9. The door closer of claim 7, wherein the speed control part comprises:
a slider having a second guide part combined with the first guide part formed on an outer circumferential surface thereof so as to move in a longitudinal direction inside the second housing part, having a third guide portion formed on an inner circumferential surface thereof, and having a first flow hole being formed therethrough;
an adjustment part combined with one end of the slider, formed in a longitudinal direction, and having a second flow hole which has a compressed tube portion and expanded tube portion and is formed in the axial direction of the slider, wherein a check ball is provided inside of the second flow hole;
a first capping part combined with inside of one end of the second housing part to seal the one end of the second housing part so as to prevent leakage of the viscous fluid;
a control bar provided at the first capping part and inserted into a third flow hole which is formed through the adjusting part along the axial direction, and provided to be spaced apart from an inner peripheral surface of the third flow hole;
an adjustment part provided at the first capping part so as to reciprocate in a longitudinal direction of the first capping part, and combined with the control bar to adjust protruded length of the control bar;
a rotating shaft part having a fourth guide portion formed on an outer circumferential surface of one end thereof, a fifth guide portion formed on the outer circumferential surface of the other end thereof, and providing rotational force to move the slider linearly by rotating integrally with the fourth fixing part;
a second capping part having a first through hole with which the rotating shaft part is combined, and combined to the rotating shaft part to prevent leakage of the viscous fluid; and
a shaft fixing part having a sixth guide portion formed on an inner circumferential surface thereof, wherein an outer circumferential surface of the shaft fixing part is combined with the fifth receiving portion so as to transmit the rotational force to the rotating shaft part.

10. The door closer of claim 9, wherein a fourth fixing protrusion is protruded inward from the fifth receiving portion, and
a fourth combining slit is formed on the outer circumferential surface of the shaft fixing part in a longitudinal direction of the shaft fixing part so that the fourth fixing protrusion is inserted and combined when the shaft fixing part is inserted into the fifth receiving portion.

11. The door closer of claim 9, wherein a cover ring is provided at the adjusting part and cover at least a portion of the expanded tube portion of the second flow hole to prevent the check ball from being discharged to the expanded tube portion of the second flow hole.

12. The door closer of claim 1, wherein the first closer part comprises:
a first hinge part comprising a first fixing part having a first receiving portion and a second fixing part having a second receiving portion and a third receiving portion which are disposed at both ends of the first receiving portion to hinge-rotate with the first fixing part;
a first housing part comprising a core portion which is disposed inside of the first receiving portion, the second receiving portion and the third receiving portion to combine the first fixing part with the second first fixing part and has a cylindrical shape, and a head portion which is formed at one end of the core portion, extends outwardly of the second receiving portion and is provided with an adjusting slit in a circumferential direction;
a rotational force providing part disposed inside of the first housing part, wherein one end of the rotational force providing part is combined with the third receiving portion, the other end of the rotational force providing part is combined with the head portion by an adjustment pin, and the and rotational force providing part provides a rotational force by a torsional elastic force to the second fixing part.

13. The door closer of claim 12, wherein the first receiving portion has a first fixing protrusion protruding inward, and
a first combining slit is formed in a longitudinal direction of the core part at the other end of the core part so that the first fixing protrusion is inserted and fixed when the core part is inserted into the first receiving portion.

14. The door closer of claim 12, wherein the rotational force providing part comprises:
a guide shaft provided inside of the core portion in a longitudinal direction of the core portion;
a torsion spring provided in the longitudinal direction of the guide shaft while surrounding the guide shaft;
a tension fixing part provided at one end of the guide shaft, having a first fixing groove which is combined with one end of the torsion spring, and combined with the third receiving portion;
a tension adjusting part provided at the other end of the guide shaft, having a second fixing groove which is combined with the other end of the torsion spring, received in the head portion, and having an adjusting groove which is formed on an outer circumferential surface of the tension adjusting part and is exposed the adjustment slit.

15. The door closer of claim 14, wherein a second fixing protrusion is protruded inward from the third receiving portion,
a second combining slit is formed on the outer circumferential surface of the tension adjusting part in a longitudinal direction of the tension adjusting part so that a second fixing protrusion is inserted thereinto when the tension adjusting part is inserted into the third receiving portion in a second direction.
